(19) United States
(12) Patent Application Publication
(10) Pub. No.: US 2010/0309846 A1
(43) Pub. Date: Dec. 9, 2010

(54) METHOD AND APPARATUS FOR USE IN A COMMUNICATIONS NETWORK

(76) Inventor: Johan Rune, Lidingo (SE)

Correspondence Address: ERICSSON INC., 6300 LEGACY DRIVE, M/S EVR 1-C-11, PLANO, TX, 75024, US

(21) Appl. No.: 12/744,874

(22) PCT Filed: Nov. 26, 2007
(86) PCT No.: PCT/EP07/62798

§ 371 Date: May 26, 2010

(51) Int. Cl. H04W 4/00

(52) U.S. Cl. 370/328

(57) ABSTRACT

A method and apparatus for use in a communications network in which a Mobile Node accesses the communications network via a proxy node. The proxy node receives a filter rule from the Mobile Node. The filter rule includes a filter rule identifier and at least one rule for applying to packets relating to the Mobile Node. The proxy node forwards the filter rule to a mobility anchor function, and also sends to the mobility anchor function information associating the filter rule to a Binding Unique Identifier, which is associated with a care-of address associated with the Mobile Node. The Binding Unique Identifier is stored at the mobility anchor function.

### TECHNICAL FIELD

The present invention relates to communications networks, and in particular to a method and apparatus for use in a Proxy Mobile IP communications network.

### BACKGROUND

Mobile IPv6 (MIPv6), which is described in IETF RFC 3775, allows users of mobile communications devices to move from one network to another whilst maintaining a permanent IP address, regardless of which network they are in. This allows the user to maintain connections whilst on the move. For example, if a user were participating in a Voice Over IP (VoIP) session and, during the session the user moved from one network to another, without MIPv6 support the user's IP address may change. This would lead to problems with the VoIP session.

A Mobile Node (MN) is allocated two IP addresses: a permanent home address and a care-of address (CoA). The CoA is associated with an access network, an IP subnet, that the user is currently visiting. To communicate with the MN, packets are sent to the MN home address. These packets are intercepted by a Home Agent (HA) in the home network, which has knowledge of the current CoA. The Home Agent then tunnels the packets to the CoA of the MN with a new IP header, whilst preserving the original IP header. When the packets are received by the MN, it removes the new IP header and obtains the original IP header. The MN sends packets to another node by tunnelling them to the HA, encapsulated in packets addressed to the HA. For each packet, the HA removes the encapsulating packet, restores the original packet and forwards it to the intended destination node.

Proxy Mobile IPv6 (PMIPv6), IETF draft-sgundave-mip6-proxymip6-02, describes a Mobile Access Gateway (MAG) function. This function emulates home link properties in order to make a MN behave as though it is on its home network and allows support for mobility on networks that would not otherwise support MIPv6. A key difference between PMIPv6 and MIPv6 is that using MIPv6, a MN has control of its own mobility signalling, whereas using PMIPv6, a MN does not have control of its mobility signalling. The basic components of a PMIPv6 architecture are illustrated in FIG. 1.

A MAG 101 is usually implemented at the access router. The MAG 101 sends and receives mobility related signalling on behalf of a MN 102. When a MN 102 connects to an access router having a MAG 101, the MN 102 presents its identity in the form of a Network Access Identifier (NAI) as part of an access authentication procedure. Once the MN 102 has been authenticated, the MAG obtains the user's profile from a policy store. The MAG 101, having knowledge of the user profile and the NAI, can now emulate the MN's home network. The MN 102 subsequently obtains its home address from the MAG. The MAG 101 also informs the MN's 102 Local Mobility Anchor (LMA) 103 of the current location of the MN 102 using a Proxy Binding Update message. The Proxy Binding Update message uses the NAI of the MN 102. Upon receipt of the Proxy Binding Update message, the LMA 103 sets up a tunnel to the MAG 101 and sends a Proxy Binding Acknowledgement to the MAG. On receipt of the Proxy Binding Acknowledgement, the MAG 101 sets up a tunnel to the LMA, effectively forming a bidirectional tunnel. All traffic to and from the MN 102 is routed through the LMA 103 via the bidirectional tunnel. A MAG may serve many MNs associated with the same LMA. The MAG and the LMA do not need to have a dedicated bidirectional tunnel for each MN. Instead the same bidirectional tunnel can be used for the traffic of all the MNs that are associated with the same LMA and that are currently being served by the same MAG.

The LMA 103 intercepts any packet that is sent to the MN 102, and forwards the intercepted packet to the MAG 101 through the tunnel. On receipt of the packet, the MAG 101 removes the tunnel header and sends the packet to the MN 102. The MAG 101 acts as a default router on the access link. Any packets sent from the MN are sent via the MAG 101 through the tunnel to the LMA 103, which then sends the packet on to its ultimate destination.

Simultaneous Multi-Access describes a function of a communications network that allows a MN to combine different radio and/or fixed access technologies, as illustrated in FIG. 2. The MN 102 can simultaneously use several interfaces and different access networks (AN1 and AN2), which may employ different access technologies, in a communications session. Different traffic flows, belonging to different applications can be transferred between different access networks, independently of each other.

MIPv6 can be extended to support Simultaneous Multi-Access (see R. Wakikawa et al., “Multiple Care-of Addresses Registration”, Internet-Draft draft-ietf-monami6-multiplecoa-02, March 2007). Where more than one access is used, a MN has a CoA for each access. A Binding Unique Identifier (BID) is associated with each CoA, and the BID indicates which CoA a Binding Update (BU) relates to. If the BID associated with a new CoA is already in use, the new CoA replaces the one previously associated with the BID, whereas if the BID is not already in use, the new CoA is added to any previously existing CoAs. Since MIPv6 is host-centric (that is to say, the MN is in control of its mobility signalling), with all the mobility signalling flowing between the MN and the HA, the MN has a complete overview and complete control of how CoAs are added to or replacing each other, by assigning the BIDs appropriately.

The mechanisms described above can also be used to extend PMIPv6, in order to provide PMIPv6 with simultaneous multi-access capabilities. However, a problem is that using PMIPv6, the MN is not in control of its mobility signalling. As described above, mobility signalling is handled by a MAG on behalf of the MN. A Proxy Binding Update (PBU) is triggered when the MN attaches to an access and the MAG responsible for the access. This means that a MN has no way of indicating its intentions regarding how the accesses are to be used in terms of PMIPv6, for example whether a new access should be added to the already used accesses or replace one or more old one(s).

The PMIPv6 LMA can operate in a Simultaneous Multi-Access mode, in which new CoAs are added to old CoAs and an old CoA is deregistered only when the MN detaches (explicitly or implicitly by losing contact) from the corresponding access.

The “binary” control of adding/replacing CoAs does not give the MN much flexibility in its control of how Simultaneous Multi-Access is used. However, the MN can be given some degree of control over Simultaneous Multi-Access by the use of filter rules, which are used for flow management.

The filter rule management, which is designed to handle flow management in Simultaneous Multi-Access scenarios, is described by C. Larsson et al., “A Filter Rule Mechanism for Multi-access Mobile IPv6” (Internet-Draft draft-larsson-monami6-filter-rules-02, March 2007. A filter rule consists of a match expression and a virtual interface identifier, denoted a Filter Interface Identifier (FIID). A filter rule indicates the CoA to which a packet matching the match expression should be routed, or the interface through which a packet matching the match expression should be routed.

To associate a filter rule with a specific interface or CoA, the filter rule's FIID is bound to an interface for packets to be sent from the node the filter rule pertains to. The FIID may also be bound to a mobility protocol specific identifier, e.g. a BID in monami6, for packets to be sent to the node the filter rule pertains to. The latter type of FIID binding (binding the FIID to a mobility protocol specific identifier, e.g. a monami6 BID) must be sent to nodes that are to send packets to the node that the filter rule pertains to (e.g. a MIPv6/monami6 HA, a MIPv6/monami6 correspondent node using the MIPv6 route optimization mode or a PMIPv6 LMA). Although filter rule management has been designed to be independent of a mobility protocol, it is particularly suited to MIPv6/monami6. Mechanisms for sending FIID-BID bindings are integrated in the monami6 signalling, as described by T. Kauppinen et al., “Filter Interface Identifier Binding in Mobile IPv6”, Internet-Draft draft-kauppinen-monami6-binding-filter-rule-00, October 2006. FIID-BID bindings are signalled in Binding Updates.

Filter rules (and FIID-interface bindings) are typically created (or otherwise installed) at the MN, which is the entity that has an overview of the available accesses, the relevant applications and the user's preferences. The filter rules for outgoing packets (from the MN) need only be stored locally in the MN, whereas the MN sends the filter rules for incoming packets (to the MN) to nodes that need them, e.g. its MIPv6/monami6 HA and CNs (using route optimization), and sends the appropriate FIID bindings (e.g. FIID-BID bindings) to these nodes. Typically, filter rules for outgoing and incoming packets are symmetric, such that outgoing and incoming packets belonging to the same flow are transferred via the same access interface, but asymmetric filter rules are also possible.

However, the mechanisms described in Internet-Draft “Filter Interface Identifier Binding in Mobile IPv6” (draft-kauppinen-monami6-binding-filter-rule-00) are not the only possible ways to bind a filter rule to a BID and to signal such a binding to a remote node. Similarly, using an FIID is not the only way to identify a filter rule. Alternative, albeit similar, mechanisms are described in the Internet-Draft “Flow Bindings in Mobile IPv6 and Nemo Basic Support” (draft-soliman-monami6-flow-binding-04). In this Internet-Draft, a Flow Identifier (FID) in combination with the MN's home address are used to identify a flow and its binding. A flow is defined using the same kind of parameters as a match expression of a filter rule (which is used to match the flow to which the filter rule applies). A flow description and a filter rule match expression therefore essentially define the same thing. Internet-Draft draft-soliman-monami6-flow-binding-04 also uses Binding Updates to signal filter rule/flow-to-BID bindings to a remote node, e.g. a Home Agent or a CN, although FIDs are used instead of FIIDs.

There are therefore different means to identify a filter rule/flow (e.g. an FIID, an FID or a combination of a home address and an FID). For the purpose of the present invention the specific details of the means for identification are not essential. The general term ‘filter rule identifier’ is used herein to refer to any type of filter rule/flow identifier, examples of which include a FIID, a FID or a combination of a home address and a FID. Similarly, the term ‘filter rule-BID binding’ is used herein to refer to a binding between a filter rule and a BID in general, whether it is using an FIID, an FID, a combination of a home address and an FID, or any other means to identify the filter rule being bound to a BID. Consequently, the term ‘filter rule-interface binding’ is used herein to refer to a binding between a filter rule and an interface in general, whether it is using an FIID, an FID, a combination of a home address and an FID or any other means to identify the filter rule being bound to an interface.

Potentially, filter rules could be used to control mobility in a Simultaneous Multi-Access situation, despite the coarse “binary” PMIPv6 Simultaneous Multi-Access mode control for adding or replacing CoAs. However, it is not simply a straightforward matter of allowing a MN to send filter rules to a LMA. In a PMIPv6 network, a MN should not be aware of its LMA and should not have a direct relation to it (ideally the MN should not even have to be aware of that it is being served by PMIPv6). Due to this circumstance the MN cannot transfer its filter rules to the LMA. Furthermore, when monami6 signalling is used in a PMIPv6 communications network, it is problematic to integrate filter rule-BID binding signalling, because PMIPv6/monami6 messages (in particular the PBUs) are sent from the MAGs instead of from the MN. A MAG does not have the necessary overview of the accesses that the MN is using, as the MN in Simultaneous Multi-Access mode may be using several different MAGs. Each MAG is unaware of other MAGs being used by the MN. Furthermore, each MAG is unaware of the filter rules that the MN has created (or otherwise installed) and their filter rule-interface bindings. A MAG therefore cannot be used to send filter rule-BID bindings to the LMA on behalf of the MN.

A further complication arises when a MN is attached to multiple different access links connected to the same MAG. In this scenario, installing filter rules in the MN and in the LMA would not suffice; the MAG must also have filter rules installed in order to know over which of its access links it should send a downlink packet. It should be noted that since all MAGs will advertise the same (home) prefix to a MN, the MN will probably not be able to distinguish this scenario from scenarios where the different access links belong to different MAGs

### SUMMARY

The relationship between the Mobile Node (MN) and the Mobile Access Gateway (MAG) is used to avoid a direct relation between the MN and a Local Mobility Anchor (LMA). This allows the MN to indirectly control how filter rules are installed and bound to Care-of-Addresses (CoAs) in the LMA. The MN does not transfer filter rules directly to the LMA, but instead via one or more MAGs, which forward(s) the filter rules to the LMA. The MN also sends implicit or explicit instructions to the MAGs on which filter rules (or filter rule identifiers) to bind to BIDs (in the PBUs that the MAGs send to the LMA).

According to a first aspect of the invention, there is provided a method for use in a communications network in which a Mobile Node accesses the communications network via a proxy node. The proxy node receives a filter rule from the Mobile Node, the filter rule comprising a filter rule identifier and at least one rule for applying to packets relating to the Mobile Node. The proxy node then forwards the filter rule to a mobility anchor function, and sends to the mobility anchor function information associating the filter rule to a Binding Unique Identifier stored at the mobility anchor function. The Binding Unique Identifier is associated with a care-of address associated with the Mobile Node. This avoids the Mobile Node transferring filter rules directly to the mobility anchor function, whilst allowing the Mobile Node to indirectly control how filter rules are bound to Care-of-Addresses stored at the mobility anchor function.

Optionally, the method further comprises sending to the mobility anchor function a Mobile Node identifier by which the mobility anchor function can identify the Mobile Node. In one option the Mobile Node identifier is selected from one of a Home Address, a Network Access Identifier and a filter rule identifier associated with the Mobile Node.

Optionally, the communications network is any on a Proxy Mobile IPv4 network and a Proxy Mobile IPv6 network, in which case the mobility anchor function is a Local Mobility Anchor function, and the proxy node is a Mobile Access Gateway. Proxy Mobile IP networks are particularly suitable for the method, although the method may be implemented in any communications network in which a node accesses the network via a proxy node.

As an option, the method further comprises, at the mobility anchor function, mapping the filter rule to a Binding Unique Identifier associated with a care-of address associated with the Mobile Node. The filter rule, the Binding Unique Identifier and the mapping between the filter rule and the Binding Unique Identifier are then all stored at the mobility anchor function. This allows the mobility anchor function to maintain the mappings and quickly obtain filter rules when required.

The method optionally comprises, at the proxy node, mapping the filter rule to a Binding Unique Identifier associated with a care-of address associated with the Mobile Node. The filter rule, the Binding Unique Identifier and the mapping between the filter rule and the Binding Unique Identifier are then stored at the proxy node. This allows the proxy node to maintain the mappings and quickly obtain filter rules when required.

Optionally, the information associating the filter rule to a Binding Unique Identifier is sent to the mobility anchor function in a Proxy Binding Update message. This avoids any unnecessary signalling.

As an option, the method comprises sending a request from the proxy node to the Mobile Node for at least part of a filter rule, the request being sent to an interface of the Mobile Node, and receiving a response from the Mobile Node, the response comprising the requested at least part of the a filter rule. This request and response procedure allows the proxy node to actively request filter rules relevant to the proxy node. In this instance, the request for information optionally comprises a request for any of filter rules associated with the Mobile Node, filter rules associated with the network node, filter rules that match packets to be sent to the same interface of the Mobile Node that the request is sent to, filter rule identifiers of all filter rules that match packets to be sent to the same interface of the Mobile Node that the request is sent to, and filter rule identifier bindings.

According to a second aspect of the invention, there is provided a proxy node for use in a communications network in which a Mobile Node accesses the communications via the proxy node. The proxy node comprises a receiver arranged to receive a filter rule from the Mobile Node, the filter rule comprising a filter rule identifier, and at least one rule for applying to packets relating to the Mobile Node. The proxy node also comprises a transmitter arranged to transmit to a mobility anchor function the filter rule and information associating the filter rule to a Binding Unique Identifier, the Binding Unique Identifier associated with a care-of address associated with the Mobile Node. The proxy node can update the mobility anchor function with filter rules on behalf of the Mobile Node without the Mobile Node being aware that it is being served by a proxy node.

As an option, the proxy node further comprises means for sending to the mobility anchor function a Mobile Node identifier by which the mobility anchor function can identify the Mobile Node.

Optionally, the proxy comprises means for mapping the filter rule to a Binding Unique Identifier associated with the Mobile Node, a memory for storing the filter rule, the Binding Unique Identifier and the mapping between the filter rule and the Binding Unique Identifier. This allows the proxy node to retrieve relevant filter rules where necessary.

As an option, the proxy node comprises means for sending a request to the Mobile Node for at least part of a filter rule, and means for receiving a response from the Mobile Node, the response comprising the requested at least part of a filter rule. This allows the proxy node to actively request any relevant filter rules from the Mobile Node.

According to a third aspect of the invention, there is provided a mobility anchor node for use in a communications network in which a Mobile Node accesses the communications via a proxy node. The mobility anchor node comprises a receiver arranged to receive from the proxy node a filter rule relating to the Mobile Node. The filter rule comprises a filter rule identifier, and at least one rule for applying to packets relating to the Mobile Node. The receiver is arranged to receive information associating the filter rule to a Binding Unique Identifier, the Binding Unique Identifier associated with a care-of address associated with the Mobile Node. The mobility anchor node also comprises means for mapping filter rule to the Binding Unique Identifier, and means for storing the filter rule, the Binding Unique Identifier, and the mapping between the filter rule and the Binding Unique Identifier. By receiving the information from the proxy node, the Mobile Node can update the mobility anchor node with filter rules indirectly, and therefore maintain control over filter rules relating to the Mobile Node.

According to a third aspect of the invention, there is provided a Mobile Node for use in a communications network in which the Mobile Node accesses the communications network via a proxy node. The Mobile Node comprises a transmitter for sending at least part of a filter rule to the proxy node, the filter rule comprising a filter rule identifier and at least one rule for applying to packets associated with the Mobile Node. The proxy node will forward the filter rule to a mobility anchor node, and so the Mobile Node can indirectly update the mobility anchor node and maintain control over its filter rules. As an option, the at least part of the filter rule is intended for use by a further node.

Optionally, the Mobile Node comprises means for sending to the proxy node only filter rules to be used for packets sent to the Mobile Node via the proxy node. This reduces the amount of data that must be transmitter compared to a situation in which the Mobile Node sent all of its filter rules, some of which may not be relevant to a particular proxy node.

Optionally, the Mobile Node comprises a receiver for receiving a request from the proxy node, the request requesting the Mobile Node to send at least part of a filter rule to the proxy node. Furthermore, the Mobile Node optionally comprises means for sending a filter rule identifier to the proxy node. These are both useful in the case that the proxy node also needs to store filter rules that may be relevant. As an option, the filter rule identifier identifies a filter rule that matches packets to be sent to the same interface of the Mobile Node that the filter rule identifier is sent from

### BRIEF DESCRIPTION OF THE DRAWINGS

FIG. 1 illustrates schematically in a block diagram a Proxy Mobile IPv6 architecture;

FIG. 2 illustrates schematically in a block diagram a Simultaneous Multi-Access architecture;

FIG. 3 is a flow diagram illustrating the steps of an embodiment of the invention;

FIG. 4 illustrates schematically in a block diagram signalling between nodes according to an embodiment of the invention;

FIG. 5 illustrates schematically in a block diagram signalling between nodes according to a further embodiment of the invention; and

FIG. 6 illustrates schematically in a block diagram a node for use according to embodiments of the invention.

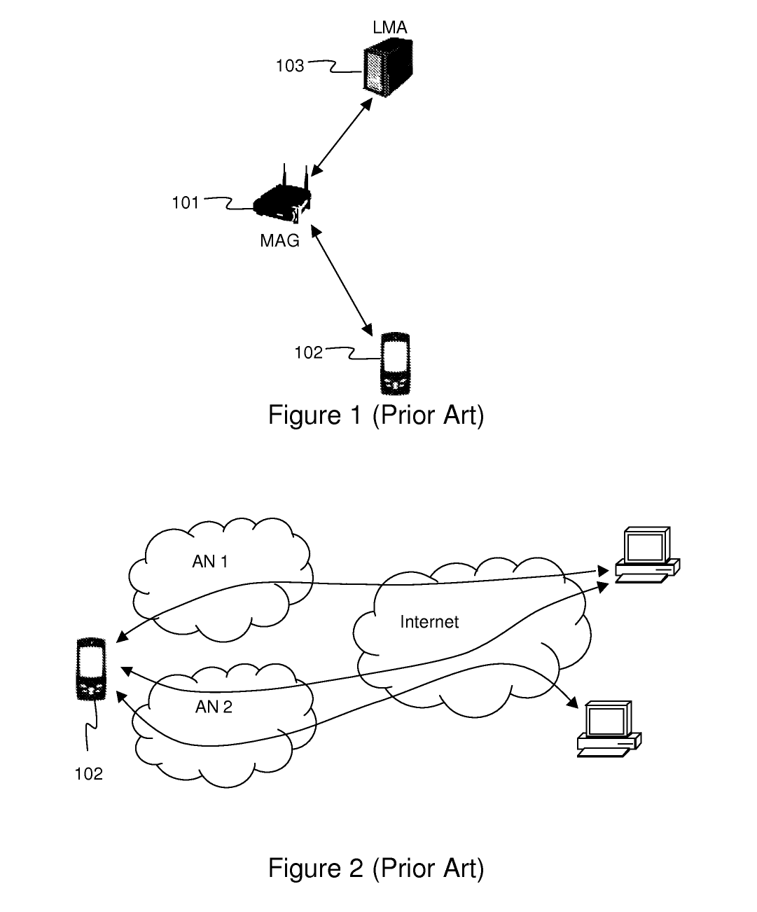

### DETAILED DESCRIPTION

The following description sets forth specific details, such as particular embodiments, procedures, techniques, etc. for purposes of explanation and not limitation. It will be appreciated by one skilled in the art that other embodiments may be employed apart from these specific details. In some instances, detailed descriptions of well known methods, interfaces, circuits, and devices are omitted so as not obscure the description with unnecessary detail. Moreover, individual blocks are shown in some of the figures. Those skilled in the art will appreciate that the functions of those blocks may be implemented using individual hardware circuits, using software programs and data, in conjunction with a suitably programmed digital microprocessor or general purpose computer, using application specific integrated circuitry (ASIC), and/or using one or more digital signal processors (DSPs).

As described above, filter rule transfer is not integrated in mobility signalling, but is instead performed using a separate protocol described in “A Filter Rule Mechanism for Multi-access Mobile IPv6” (draft-larsson-monami6-filter-rules-02). Whilst a Mobile Node (MN) can in principle transfer its filter rules directly to a Local Mobility Anchor (LMA), this would require the MN to be aware of the LMA that serves the MN. In most cases, it would also be necessary for the MN and the LMA to have a security relationship. This negates one of the main advantages of PMIPV6, namely that an MN is unaware of its LMA and is unaffected by the mobility signalling, which is handled on behalf of the MN by a Mobile Access Gateway (MAG).

However, a direct relationship between the MN and the LMA can be avoided by using the MN's relationship with a MAG. Filter rules are not sent directly from the MN to the LMA, but instead to a MAG. The MAG forwards the filter rules to the LMA and subsequently sends appropriate filter rule-BID bindings, as explicitly or implicitly indicated by the MN, to the LMA using PMIPv6/monami6 Proxy Binding Updates (PBUs).

When a MAG forwards filter rules to the LMA the message containing the rules includes an indication of which MN the filter rules pertain to. The best way to achieve this is for the filter rules to contain the MN's (home) address in the match expression. However, other ways to identify the MN that the filter rule pertains to include any of the following:
When the MAG receives a filter rule, it includes the MN's address as a new parameter in a filter rule transfer message before forwarding the rule to the LMA.
When the MAG receives a filter rule, it rewrites all the match expressions that do not include the MN's address so that the MN's address is included, before forwarding the rule to the LMA.
When the MAG receives a filter rule without the MN's address, it rejects the filter rule transfer message from the MN with a status code indicating the reason.
When the MAG receives a filter rule without the MN's address, it forwards the message to the LMA. The LMA then rejects the message with a status code indicating the reason. The MAG forwards the rejection message to the MN.
When the MAG receives a filter rule, it includes the MN's Network Access Identifier as a new parameter in a filter rule transfer message before forwarding the rule to the LMA.
The MN may be identified by the filter rule identifier(s) in the filter rule transfer message, in case a filter rule identifier contains an identity tag of the MN or one of the MN's interfaces (which is assumed for an FIID).

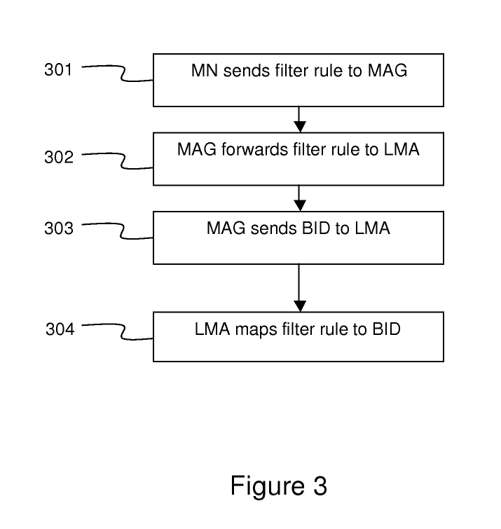

FIG. 3 illustrates the basic steps according to an embodiment of the invention. The steps are explained with reference to the numbering of FIG. 3.
301. The MAG receives a filter rule sent from the MN, the filter rule comprising at least one rule to apply to packets associated with the MN;
302. The MAG forwards the filter rule to the LMA;
303. The MAG also sends to the LMA information allowing the LMA to map the filter rule to a BID associated with the MN. This may or may not be in the same message as that sent in step 302.
304. Once the LMA has received the filter rule and the mapping information, it maps the BID to the filter rule.

The filter rule transfer protocol allows any nodes to exchange filter rules. For instance, a server can transfer filter rules pertaining to a MN to another node on behalf of that MN. Another example is the procedure illustrated in FIG. 3 according to an embodiment of the invention, in which the MAG forwards the filter rules to the LMA on behalf of the MN. This means that if the MN's address is not always included in the match expression of the filter rules, a separate message parameter indicating the address of the node that the filter rules pertain can be used. This is regardless of the type of network in use, and has use in networks other that PMIP networks.

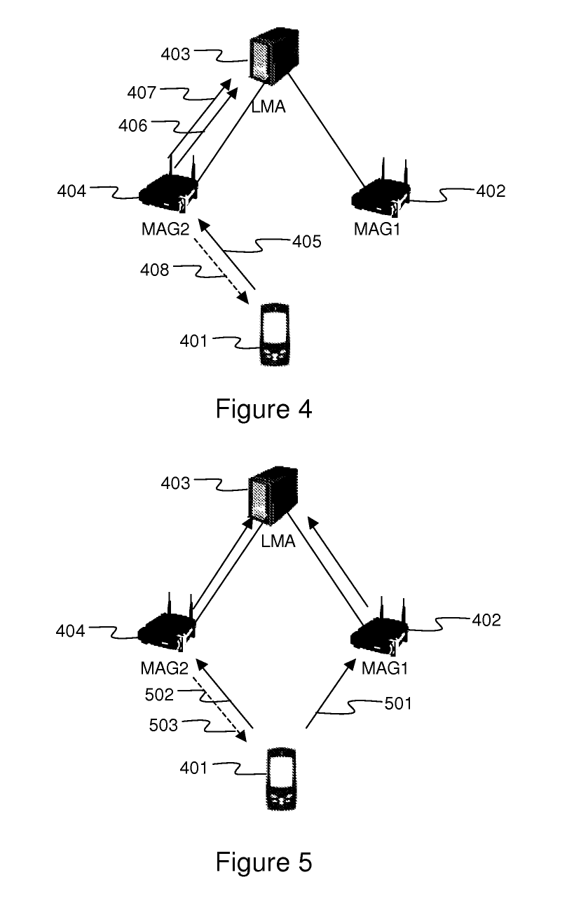

Turning now to a particular embodiment of the invention in more detail, FIG. 4 illustrates schematically signalling between nodes. A MN 401 is served by a MAG1 402, which sends mobility signalling on behalf of the MN 401 to a LMA 403. MAG2 404 is a new MAG to which the MN 401 attaches in a Simultaneous Multi-Access scenario.

MAG2 404 is only aware of any BID(s) that it has itself registered in the LMA 403. Consequently, MAG2 can only bind a filter rule identifier to its own BID(s) (unless explicitly informed of BID(s) registered by other MAG(s)). Therefore the MN 401 uses each MAG 402, 404 as a relay point for any filter rules that pertain to the respective MAG. For example, MN 401 selectively transfers to MAG2 404 only the filter rules for which matching downlink packets should be routed via MAG2 404. If the MN 401 uses symmetric filter rules, this means that the filter rules transferred to MAG2 404 are the ones that correspond to the filter rules that in the MN 401 (via the filter rule identifiers) are bound to the interface that is attached to the access controlled by the MAG2 404.

Filter rules are sent 405 from the MN 401 to MAG2 404. When receiving filter rules from the MN 401, MAG2 404 extracts the filter rule identifiers from the rules before forwarding 407 the filter rules to the LMA. MAG2 404 then sends 406 a PBU to the LMA, the PBU indicating the filter rule-BID bindings. In this way, MAG2 404 binds the filter rule identifiers it received from the MN to the BID it has registered in the LMA for the PMIPv6 CoA for the MN.

If a filter rule is already present in the LMA 403, and requires its filter rule-BID binding to be updated, the MN 401 can indicate this by sending only the filter rule identifier (i.e. excluding the match expression) for that filter rule to MAG2 404. MAG2 404 removes this filter rule (by removing. the filter rule identifier) from the message before forwarding the message 407 to the LMA 403.

The filter rules are transferred (both between the MN 401 and MAG2 404 and between MAG2 404 and the LMA 403) using the protocol described in the Internet-Draft “A Filter Rule Mechanism for Multi-access Mobile IPv6” (draft-larsson-monami6-filter-rules-02), although other suitable protocols may be used. The filter rule-BID bindings are signalled through PMIPv6/monami6 using the BID sub-option as described in Internet-Draft “Filter Interface Identifier Binding in Mobile IPv6” (draft-kauppinen-monami6-binding-filter-rule-00), or any other protocol mechanism that is designed to carry associations between filter rules and BIDs in monami6.

According to C. Larsson et al., “A Filter Rule Mechanism for Muti-Access Mobile IPv6”, draft-larsson-monami6-filter-rules-02, March 2007, a filter rule transfer includes a complete set of filter rules which is used to replace all existing filter rules. This is not in line with the partial filter rule transfers proposed above, in which a MAG can update the binding of a single filter rule in the LMA 403. However, C. Larsson et al also mention the possibility of introducing “delta” filter rule transfer messages to indicate changes to filter rules, changes including additions of new filter rules, deletions of old filter rules and updates of existing filter rules. According to the present invention, the MN need only send delta filter rule messages to be forwarded by the MAGs. “Deltas”, which do not require subsequent filter rule-BID binding signalling (that is, filter rule deletions and changes which maintain their filter rule-BID binding), are sent via any available MAG. On the other hand, “deltas” which do require subsequent filter rule-BID binding signalling (for example, additions of new filter rules, replacement of existing filter rules, and any other changes which include filter rule identifier updates or require subsequent filter rule-BID binding changes) are sent via the MAG that signals the subsequent filter rule-BID bindings to the LMA 403.

Internet-Draft “Filter Interface Identifier Binding in Mobile IPv6” (draft-kauppinen-monami6-binding-filter-rule-00) allows a filter rule identifier to be bound to multiple BIDs in order to enable bi-casting and certain load balancing features. This feature is disabled for Simultaneous Multi-Access scenarios using PMIP network. This ensures that a new registered filter rule-BID binding always replaces any previous filter rule-BID binding for the same filter rule identifier in the LMA 403.

The solution described above has certain disadvantages. One disadvantage is that a MAG will send two PBUs for each BID: The first one is to register the BID and CoA, triggered by the attachment of the MN, and then, after receiving filter rules from the MN, a second PBU is sent to the LMA to register the filter rule-BID bindings.

A further disadvantage is that the solution requires the MN 401 to transfer filter rules for every newly attached access (although it is possible to send filter rule identifiers without associated match expressions, which ameliorates this problem). It is desirable to separate filter rule creation, installation and transfer from the binding of the filter rule to interfaces/CoAs/BIDs. It is better for filter rule creation, installation and transfer to be triggered by application initiations (or socket requests), and filter rule identifier bindings to be triggered by movements (or new accesses) of the MN.

A way to avoid sending two PBUs from a MAG to the LMA is for a MAG (in the example of FIG. 4, MAG2 404) to request 408 the relevant filter rules from the MN 401 before sending the (first) PBU to the LMA. The MAG can then register the CoA and BID and indicate the filter rule-BID bindings in the same (single) PBU and thus there is no need for a second PBU. The request is for the MN to provide to the MAG those filter rules that match downlink packets that should be sent to the interface that the request is sent to, i.e. the interface attached to the access link of the MAG, that the MN would otherwise send to the MAG without solicitation.

A filter rule request message may be implemented in networks other than PMIP networks, and used, for example, for recovery purposes. The following request types are examples of requests that may be made:
1. A request for all filter rules of the MN. An example of when this is used is when the requester, for example a Home Agent, has lost the filter rules.
2. A request for those filter rules that are relevant to the requesting node (as determined by the MN). An example of when this is used is when the requester, for example a correspondent node, has lost the filter rules.
3. A request for those filter rules that match packets to be sent to the same interface as the request is sent to.
4. A Request for filter rule identifiers to be bound to the packet route (in terms of BID, CoA, interface, etc.) towards the same interface as the request is sent to. (E.g. if the requester has retained the filter rules but lost the filter rule identifier bindings.)
5. A request that the MN resends all filter rule identifier bindings. This is used, for example, if the requester has retained the filter rules but lost the bindings.

If the MN has nothing to send in response to the requester, for example because it has no installed filter rules relevant to the request, the MN either returns an empty message or rejects the request with an appropriate cause value. Introducing this request mechanism as a regular feature in the filter rule management concept is desirable, not only because it could be useful for filter rule management in general, but also because it would facilitate interaction with PMIPv6-unaware MNs using Simultaneous Multi-Access. If Simultaneous Multi-Access is not allowed for the MN, the MAG would be informed of this via AAA signalling during the network access procedure and would not request filter rules/filter rule identifiers or associate a BID with the CoA.

A way to minimize traffic and avoid unnecessary sending of filter rules is for the MN to send filter rule identifiers without associated match expressions if only filter rule-BID bindings are needed. In this case, the actual filter rules are not sent to the LMA.

As the MN only sends to a given MAG those filter rules that are relevant for the interface through which the filter rule message is sent, the MAG can keep the filter rules that it receives and bind them to the access link over which they were received. This is beneficial where the MAG is connected to multiple access links. It is beneficial to include an indication for each filter rule in the filter rule transfer message from the MN to the MAG. The indication indicates whether or not the filter rule is new or updated and hence is forwarded to the LMA.

An alternative to installing filter rules in a multi-access link MAG is to ensure that a MAG with multiple access links uses a different CoA (i.e. a different MAG-LMA tunnel) for each access link. In this case, filter rules need not be installed in the MAG.

In an alternative embodiment of the invention, illustrated in FIG. 5, filter rule transfers and filter rule-BID binding signalling are sent separately in accordance with the original intention of the filter rule management design. Instead of using the filter rule transfers from the MN 401 to a MAG as implicit indications of filter rules for which the MAG should signal filter rule-BID bindings to the LMA 403, the MN 401 separates filter rule transfers from indications of filter rule identifiers to be bound to BIDs by MAGs. The MN 401 still sends 501 the filter rules to the LMA 403 via a MAG 402, because it does not know the address of its LMA 403. The MN 401 can transfer any filter rules through any MAG 402, 404, and it does so only when filter rules are created, deleted or updated (or refreshed if such a mechanism is used). Partial transfers of selected filter rules via different MAGs are not needed—everything can be transferred via a single (arbitrary) MAG.

To instruct a MAG 404 to signal filter rule-BID bindings to the LMA 403, the MN 401 sends 502 a message including the filter rule identifier to be bound to the MAG's BID. This message can be considered to be a filter rule transfer message including filter rules with empty or excluded match expressions, i.e. filter rules containing only filter rule identifiers. The same protocol may be used for filter rule identifier transfers and the filter rule transfers, i.e. the protocol described in the Internet-Draft “A Filter Rule Mechanism for Multi-access Mobile IPv6” (draft-larsson-monami6-filter-rules-02).

This still results in two PBUs being sent from a MAG to the LMA 403; one to register the CoA and one to signal the filter rule-BID bindings. However, as with the first embodiment, the MAG can request 503 the required information from the MN before sending the (first) PBU thereby eliminating the need for the second PBU. In this solution the request type to use would be a request for the MN to send the filter rule identifiers to be bound to the route towards the interface that the request is sent to (number 4 in the above list).

A simple way to handle the multi-access link MAG scenario with this solution is to ensure that a MAG with multiple access links use a different CoA (i.e. a different MAG-LMA tunnel) for each access link. In this case, no filter rules need be installed in the MAG.

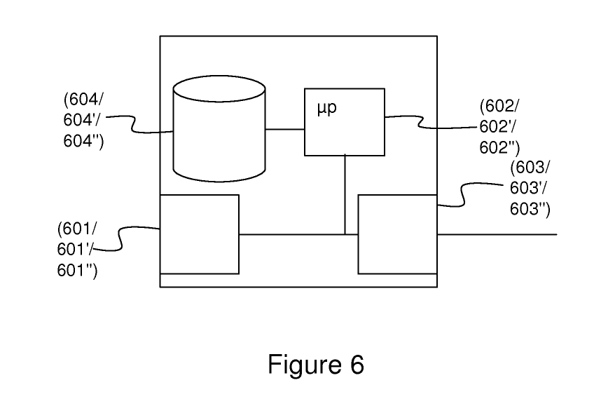

Referring to FIG. 6 herein, there is illustrated a node for use in a Proxy Mobile IP communications network. In one embodiment the node is a proxy node such as a MAG. The MAG comprises a receiver 601 for receiving signalling from the MN, such as the filter rule. The MAG further comprises a processor 602 for processing signalling, and a transmitter 603 for sending signalling to the LMA. The MAG may comprise a memory 604 for storing filter rules and bindings relating to the filter rules.

The node of FIG. 6 may also illustrate a mobility anchor node such as an LMA. The LMA comprises a receiver 601′ for receiving communications from one or more MAGs, a processor 602′ for mapping a filter rule identifier to a BID, and a memory 604′ for storing filter rule identifiers, BIDs, and mapping information. The LMA further comprises a transmitter 603′ for sending signalling to the MAGs.

The node of FIG. 6 may also illustrate a Mobile Node. The Mobile Node comprises a transmitter 603″ for sending filter rules, or parts of filter rules, that are stored in a memory 604″, to a proxy node. The filter rule also comprises a receiver 601″ for receiving a request from a proxy node to send all relevant filter rules, as described above.

The above described embodiments of the invention overcome problems associated with filter rule management in conjunction with PMIPv6. A way is provided for a MN to convey filter rules to a PMIPv6 LMA, and the MN to indirectly control the filter rule-BID bindings, and hence the flow management, in conjunction with PMIPv6 in a Simultaneous Multi-Access scenario.

It will be appreciated by the person of skill in the art that various modifications may be made to the above described embodiments without departing from the scope of the present invention. For example, whilst the invention is described using the examples of Proxy MIP or PMIPv6, it will be appreciated that it may also be used for any protocol that support gateways or proxy gateways.

The following acronyms are used in this specification:

### AAA Authentication, Authorization & Accounting

### BID Binding Unique Identifier

### BU Binding Update

### CN Correspondent Node

### CoA Care-of Address

### FID Flow Identifier

### FIID Filter Interface Identifier

### HA Home Agent

### IP Internet Protocol

IPv6 Internet Protocol version 6

### LMA Local Mobility Anchor

### MAG Mobile Access Gateway

### MIPv6 Mobile IPv6

### MN Mobile Node

### NAI Network Access Identifier

### PBU Proxy Binding Update

### PMIPv6 Proxy Mobile IPv6

RFC Request For Comments

1.-20. (canceled)

21. A method for use in a communications network in which a Mobile Node accesses the communications network via a proxy node, the method comprising:
at the proxy node, receiving a filter rule from the Mobile Node, the filter rule comprising a filter rule identifier and at least one rule for applying to packets relating to the Mobile Node;
forwarding the filter rule to a mobility anchor function; and
subsequently sending to the mobility anchor function in a separate message information associating the filter rule to a Binding Unique Identifier stored at the mobility anchor function, the Binding Unique Identifier associated with a care-of address associated with the Mobile Node.

22. The method according to claim 21, further comprising sending to the mobility anchor function a Mobile Node identifier by which the mobility anchor function can identify the Mobile Node.

23. The method according to claim 21, further comprising sending to the mobility anchor function a Mobile Node identifier by which the mobility anchor function can identify the Mobile Node, wherein the Mobile Node identifier is selected from one of a Home Address, a Network Access Identifier and a filter rule identifier associated with the Mobile Node.

24. The method according to claim 21, wherein the communications networks is selected from one of a Proxy Mobile IPv4 network and a Proxy Mobile IPv6 network, the mobility anchor function being a Local Mobility Anchor function, and the proxy node being a Mobile Access Gateway.

25. The method according to claim 21, further comprising:
at one of the mobility anchor function and the proxy node, mapping the filter rule to a Binding Unique Identifier associated with a care-of address associated with the Mobile Node; and
storing the filter rule, the Binding Unique Identifier and the mapping between the filter rule and the Binding Unique Identifier.

26. The method according to claim 21, wherein the information associating the filter rule to a Binding Unique Identifier is sent to the mobility anchor function in a Proxy Binding Update message.

27. The method according to claim 21, further comprising:
sending a request from the proxy node to the Mobile Node for part of a filter rule, the request being sent to an interface of the Mobile Node; and
receiving a response from the Mobile Node, the response comprising the requested part of a filter rule.

28. The method according to claim 21, further comprising:
sending a request from the proxy node to the Mobile Node for part of a filter rule, the request being sent to an interface of the Mobile Node;
receiving a response from the Mobile Node, the response comprising the requested part of a filter rule, wherein the request for information comprises a request for any of:
filter rules associated with the Mobile Node;
filter rules associated with the network node;
filter rules that match packets to be sent to the same interface of the Mobile Node as the request;
filter rule identifiers of all filter rules that match packets to be sent to the same interface of the Mobile Node that the request is sent to; and
filter rule identifier bindings.

29. A proxy node for use in a communications network in which a Mobile Node accesses the communications via the proxy node, the proxy node comprising:
a receiver arranged to receive a filter rule from the Mobile Node, the filter rule comprising a filter rule identifier, and at least one rule for applying to packets relating to the Mobile Node; and
a transmitter arranged to transmit the filter rule and in a separate message information associating the filter rule to a Binding Unique Identifier, the Binding Unique Identifier associated with a care-of address associated with the Mobile Node, to a mobility anchor function.

30. The proxy node according to claim 29, further comprising means for sending to the mobility anchor function a Mobile Node identifier by which the mobility anchor function can identify the Mobile Node.

31. The proxy node according to claim 29, further comprising:
mapping means for mapping the filter rule to a Binding Unique Identifier associated with the Mobile Node; and
storage means for storing the filter rule, the Binding Unique Identifier and the mapping between the filter rule and the Binding Unique Identifier.

32. The proxy node according to claim 29, further comprising:
transmitter means for sending a request to the Mobile Node for part of a filter rule; and
receiver means for receiving a response from the Mobile Node, the response comprising the requested part of a filter rule.

33. A mobility anchor node for use in a communications network in which a Mobile Node accesses the communications via a proxy node, the mobility anchor node comprising:
a receiver arranged to receive from the proxy node a filter rule relating to the Mobile Node, the filter rule comprising a filter rule identifier, and at least one rule for applying to packets relating to the Mobile Node, the receiver being further arranged to receive information associating the filter rule to a Binding Unique Identifier, the Binding Unique Identifier associated with a care-of address associated with the Mobile Node;
mapping means for mapping the filter rule to the Binding Unique Identifier; and
storage means for storing the filter rule, the Binding Unique Identifier, and the mapping between the filter rule and the Binding Unique Identifier.

34. A Mobile Node for use in a communications network in which the Mobile Node accesses the communications network via a proxy node, the Mobile Node comprising:
a transmitter for sending part of a filter rule to the proxy node, the filter rule comprising a filter rule identifier and at least one rule for applying to packets associated with the Mobile Node.

35. The Mobile Node according to claim 34, wherein the part of a filter rule is intended for use by a further node.

36. The Mobile Node according to claim 34, comprising any of:
a transmitter for sending to the proxy node only filter rules to be used for packets sent to the Mobile Node via the proxy node;
a receiver for receiving a request from the proxy node, requesting the Mobile Node to send at least part of a filter rule to the proxy node; and
means for sending a filter rule identifier to the proxy node.

37. The Mobile Node according to claim 34, wherein the Mobile Node comprises means for sending the filter rule identifier to the proxy node, and the filter rule identifier identifying a filter rule that matches packets to be sent to the same interface of the Mobile Node from which the filter rule identifier is sent.
